(19) United States
(12) Patent Application Publication
(10) Pub. No.: US 2017/0075851 A1
(43) Pub. Date: Mar. 16, 2017

(54) MULTIFUNCTION EXPANSION MODULE

(71) Applicant: Uniwill Technology Company, Taipei City (TW)

(72) Inventors: Ying-Fu CHOU, Taipei City (TW); Sheng-Hung TSAI, Taipei City (TW); Hui ZHANG, Taipei City (TW)

(21) Appl. No.: 14/855,770

(22) Filed: Sep. 16, 2015

(51) Int. Cl. G06F 13/40

(52) U.S. Cl. CPC G06F 13/4081

(57) ABSTRACT

A multifunction expansion device includes a driving unit, an expansion unit and a connecting unit. The multifunction expansion device is characterized that, the expansion unit is electrically connected to the driving unit and the connecting unit. The expansion unit further includes an input and output device and a signal device. The input and output device is provided with a plurality of connecting pins, and allows a plurality of connecting pins to enable corresponding connection and transmission through connecting pin combinations in different quantities and operating with the signal device. Accordingly, by utilizing various combinations of idle connecting pins and operating with the signal device, the expansion unit allows the driving unit to operate devices of the connecting unit, thereby allowing the expansion module to correspond with various devices.

### BACKGROUND OF THE INVENTION

a) Field of the Invention

The invention relates to a general module. The expansion module utilizes multiple combinations of idle connecting pins to allow the expansion module to correspond with various devices.

b) Description of the Prior Art

In the current information era, almost every person has one or even several of mobile devices, tablet computers, laptop computers, and desktop computers. Through these devices, information exchange is made more smooth and circulative.

Laptop computers are targeted at offering easy portability and convenience. To connect the laptop computers to peripheral hardware devices through existing connecting interfaces for transmission, a current connecting method is implemented by connecting one hardware device to one connector. For example, to connect a common laptop computer through a USB (Universal Serial Bus) device interface to an associated peripheral device, one device is corresponded to one connecting interface. As shown in FIG. 1, a host 10 includes one or more connecting devices 11, and has one of the connecting devices 11 corresponding through a hardware device 12 to allow the host 10 to drive the hardware device 12. If the connector is incompatible or insufficient, such corresponding connection and transmission cannot be performed. Not only additional adaptor devices need to be purchased but also equipment costs cannot be saved.

Therefore, to solve the above issues, it is an object and direction of related industrialists to develop, research and provide a more practical structure for satisfying consumer needs.

In view of the above, based years of manufacturing, development and design experiences of related products, the Applicant provides a practical invention after thorough design and evaluation to achieve the above object.

### SUMMARY OF THE INVENTION

It is a primary object of the present invention to provide a multifunction expansion module for solving issues of a conventional solution in which one single device corresponds to one single connection interface instead of corresponding multiple types of connecting devices to one single connection interface.

A technical feature of an expansion module of the present invention for solving the above issues is applying combinations of idle connecting pins. The expansion module includes a driving unit, an expansion unit and a connecting unit. The expansion unit is electrically connected to the driving unit and the connecting unit and further includes an input and output device and a signal device, and the input and output device is provided a plurality of connecting pins. By coordinating connecting pin combinations in different quantities with the signal device, a plurality of connecting units is be applied for corresponding connection and transmission. Therefore, by utilizing different combinations of idles connecting pins operating with the signal device, the expansion unit allows the driving unit to be connected and to operate devices of the connecting unit, such that the expansion module can correspond to various devices.

It is a secondary object of the present invention to provide the connecting unit that can be implemented by a power supply device, a storage device, a communication device, a network device and a television device, correspondingly.

It is another object of the present invention to provide the input and output device of the expansion unit, with the input and output device formed by a plurality of pins. The pins are a combination of two or more pins that operate with the signal device, and are implemented by connecting and corresponding to different connecting units to drive the driving unit.

It is another object of the present invention to provide the input and output device of the expansion unit, with the input and output device formed by a plurality of connecting pins implemented correspondingly by providing a plurality of connecting units.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a schematic diagram corresponding to a conventional connecting device;

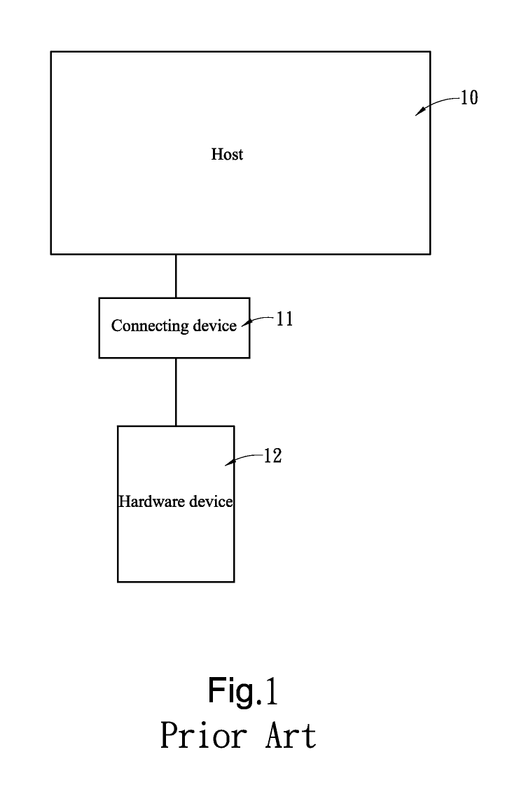

FIG. 2 is a schematic diagram of corresponding connections of a multifunction expansion device of the present invention; and

FIG. 3 is a schematic diagram corresponding to an input and output device of a multifunction expansion module according to an embodiment of the present invention.

### DETAILED DESCRIPTION OF THE PREFERRED EMBODIMENTS

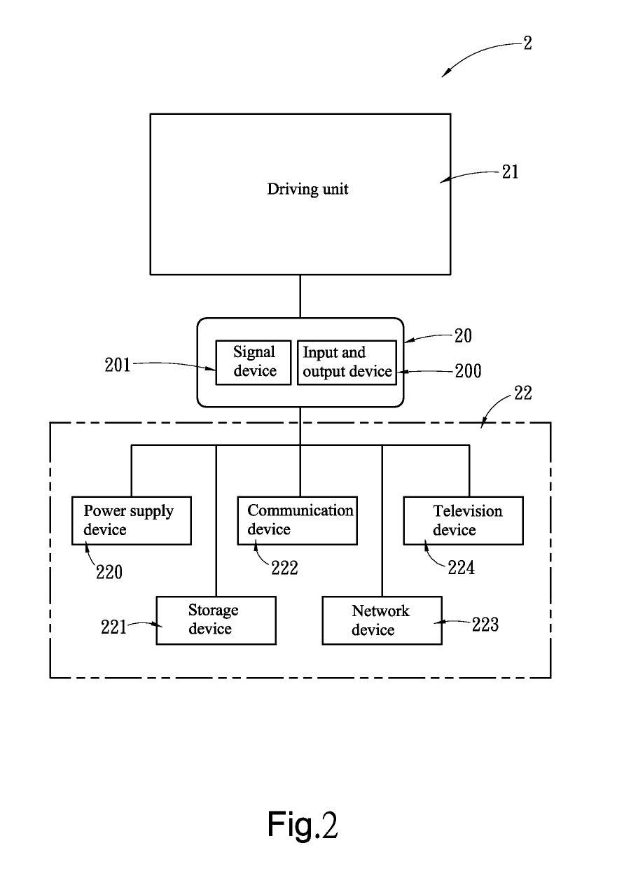

Referring to FIG. 2, an expansion module 2 of the present invention includes a driving unit 21, an expansion unit 20, and a connecting unit 22. The driving unit 21 is disposed in a computer host, provides the expansion unit 20 with electrical connection, and drives the connecting unit 22 through the expansion unit 20.

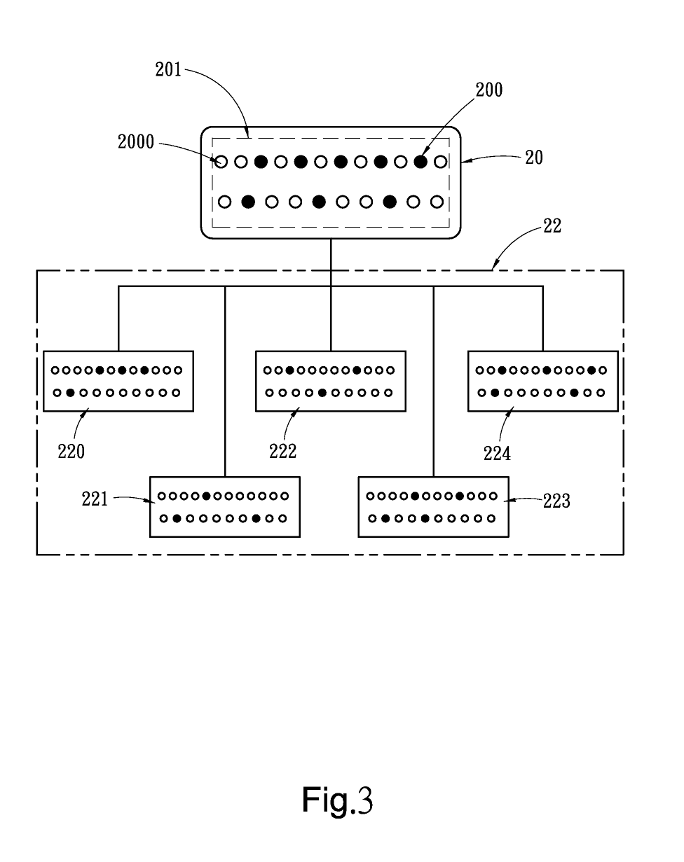

The expansion unit 20 includes an input and output device 200 and a signal device 201. The input and output device 200 is formed by a plurality of connecting pins 2000 (not shown in FIG. 2 and may be referred from FIG. 3). The plurality of connecting pints 2000 correspond with the connecting unit 22, and include idle connecting pins that can be paired with a corresponding contact signal combination of the connecting unit 22, such that the input and output device 200 is correspondingly connected to various connecting units 22.

The signal device 201 is a receiving device that serves as electrical connection between the input and output device 200 and the driving unit 21. According to the connection between the input and output device 200 and the devices of the connecting unit 22 and by corresponding the connecting unit 22 to difference devices, the signal device 201 transmits different signals into the driving unit 21 to allow the driving unit 21 to drive the corresponding device.

The driving unit 21, as an operating element, is electrically connected to the expansion unit 20 and the connecting unit 22, and provides signal transmission and operations.

The connecting unit 22 is an externally connected hardware device, and corresponds to the expansion unit 20. For example, the connecting unit 22 can be implemented by various devices such as a power supply device 220, a storage device 221, a communication device 222, a network device 223 or a television device 224. The connecting unit 22 is paired and combined with different signals via the idle connecting pins 2000 of the expansion unit 20, so as to allow the expansion unit 20 to correspond with one or more connecting units 22.

Thus, by combining and pairing with the connecting pins 2000 of the input and output device 200 of the expansion unit 20, the expansion module 2 provides one or more connecting units 22 with a corresponding connection. Further, with the transmission through the signal device 201 of the expansion unit 20, the driving unit 21 is allowed to operate the connecting unit 22 to provide more extensive corresponding connection applications.

Refer to FIG. 3 showing a schematic diagram corresponding to an input and output device 200 of an expansion unit 20 of the present invention. The input and output device 200 of the expansion unit 20 includes a plurality of connecting pins 2000. The expansion unit 20 provides a hard drive correspondence, and eight of the corresponding connecting pins 2000 are idle. These idle connecting pins 2000 are used to connect to various devices of the connecting unit 22. Further, two or more of the connecting pins 2000 are arranged in a combination. For example, the combination may be, four connecting pins 2000 of two rows are set to correspond to the power supply device 220, and three connecting pins 2000 of the two rows are set to correspond to the storage device 221. According to required signals, the input and output device 200 sets the connecting pins 2000 in different arrangements regarding rows and columns, so as to allow the expansion unit 20 to correspond to one or more connecting units 22, thereby enhancing the expansion practicability of the present invention.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A multifunction expansion module, comprising a driving unit, an expansion unit and connecting unit, wherein,
the expansion unit is electrically connected to the driving unit and the connecting unit; the expansion unit is provided with an input and output device and a signal device; the input and output device is provided with a plurality of connecting pins, and operated with the signal device through connecting pin combinations in different quantities to allow a plurality of connecting units for corresponding connection and transmission; accordingly, by utilizing various combinations of idle connecting pins and operating with the signal device, the expansion unit allows the driving unit to operate devices of the connecting unit, thereby allowing the expansion module to correspond with various devices.

2. The multifunction expansion module according to claim 1, wherein the connecting unit is implemented by a power supply device, a storage device, a communication device, a network device or a television device.
